(19) United States
(12) Patent Application Publication
(10) Pub. No.: US 2012/0323768 A1
(43) Pub. Date: Dec. 20, 2012

(54) SMS BENEFICIARY ADVISING

(75) Inventors: Howard O. Weinstein, Boston, MA (US); William E. Thomas, Charlotte, NC (US); Daniel M. Whipple, Charlotte, NC (US); Christopher Hope, Charlotte, NC (US); Savit A. Pirl, Bolingbrook, IL (US)

(73) Assignee: Bank of America, Charlotte, NC (US)

(21) Appl. No.: 13/218,613

(22) Filed: Aug. 26, 2011

Related U.S. Application Data
(60) Provisional application No. 61/496,931, filed on Jun. 14, 2011.

(51) Int. Cl. G06Q 40/00

(52) U.S. Cl. 705/39

(57) ABSTRACT

Apparatus and methods for communicating a notification of a status of a payment are provided. The payment may be an electronic payment. The apparatus and methods may involve receiving an electronic request from a payor to transmit a payment to a payee. The status of a payment may include steps that have been completed, have not been completed, and/or are currently in progress in a process of fulfilling the payor's request. Status may include an estimate of time remaining until the fulfillment process is completed. The electronic request may include a notification preference. A notification preference may include a destination for receiving the notification. A method of communicating a notification may include any suitable paper or electronic communication method. The notification may be automatically stored in a database for future reference.

### CROSS-REFERENCE TO RELATED APPLICATION

This application is a nonprovisional of U.S. Provisional Application No. 61/496,931 filed on Jun. 14, 2011 which is hereby incorporated by reference in its entirety.

### FIELD OF TECHNOLOGY

Aspects of the disclosure relate to communication of a notification of a status of a payment.

### BACKGROUND

Electronic payments (“billpay”) have become a common capability in banks and other financial institutions that offer e-commerce websites. Typically, an internet website platform is used to facilitate payment, by a payor to a payee, of bills and debts. Payors and payees may include consumers, small business customers and others. Billpay may encompass payment of bills, debts and other monetary transactions.

Payments may be effected by paper or electronic check, electronic fund transfer, third party payment network such as the Automated Clearinghouse (“ACH”), general ledger transfer in a closed-loop payments network such as PayPal®, or through other suitable means for effecting fund transfer between parties.

When a payor makes a payment, the payee may not be aware of the incoming payment. The payee may not be aware of a status of the incoming payment. It would be desirable, therefore, to provide apparatus and methods for SMS beneficiary advising.

### SUMMARY OF THE DISCLOSURE

It is an object of this disclosure to provide apparatus and methods for transmitting a notification regarding a status of a requested payment. The payment may be requested in electronic form. The requested payment may include a file attachment or other data object.

A notification may be transmitted confirming submission of the requested payment. A notification may be transmitted indicating that the payment has been credited to a payee. A notification may include a date and time a payment was requested by the payor or an expected date the payment will be credited to the payee.

The notification may also include a status of a payment. The status of a payment may include steps that have been completed in a process of fulfilling the requested payment. A notification may include an explanation for a time lag in crediting a payment to a payee.

A notification may include an electronic link for a payee to access a file attachment associated with the payment. A notification may be transmitted to a payor indicating that a payee has accessed a file attachment.

The notification may be transmitted to a location specified by a payor or a payee. The location may be a mobile device and may be transmitted via a SMS text message. The location may be specified by an international phone number.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of apparatus that may be used in accordance with the principles of the invention;

FIG. 2 shows a process in accordance with the principles of the invention;

FIG. 3 shows illustrative information that may be included in a notification;

FIG. 4 shows a process in accordance with the principles of the invention; and

FIG. 5 shows an illustrative format of a notification in accordance with the principles of the invention.

### DETAILED DESCRIPTION OF THE DISCLOSURE

It is an object of this invention to provide apparatus and methods for communicating a notification of a status of a payment.

Apparatus and methods for communicating a notification relating to a payment are provided. The payment may be an electronic payment. An electronic payment typically involves a paying or transferring party (“payor”), an intermediary (such as a bank, a billpay service or a billpay network) and a payee.

The apparatus and methods may involve receiving an electronic request from the payor and transmitting a notification. The request may be a request to transmit a payment to the payee. The notification may include information related to a status of the payment.

The status of a payment may include steps that have been completed in a process of fulfilling the requested payment. The status of a payment may include steps in the fulfillment process that are currently in-progress.

The status of a payment may include steps in the fulfillment process that have not yet been completed and/or an estimate of time needed to the complete the fulfillment process. A notification may include an explanation for a time lag in crediting a payment to a payee.

The notification may be transmitted to the payor, the payee, a third party or two or more of the payor, payee and the third party. The notification may be communicated from the payor, the payee, a third party or two or more of the payor, payee and the third party.

In some embodiments, a preference regarding a notification may be set. A preference may include whether notifications are received at all. A preference may also include a selection as to whether to receive a notification based on a parameter. A parameter may include a value of a payment, a merchant and/or a classification of a payment or any other suitable parameter.

A preference may include when and/or at what interval a notification is provided. For example, a notification may be provided in real time, in a batch processing format at some predetermined interval or may be sent at a specific time.

A notification preference may be determined by a payor, payee or third party. A notification preference may include a destination for receiving a notification.

A notification preference may include a method of notification. A method of communicating a notification may include any suitable paper or electronic communication, including postal letter, electronic mail, text message, telephone, fax or any other suitable communication method. A notification preference may include a number to which a text message should be communicated. The number may include an international phone number.

A notification preference may specify content to be included in a notification.

Content of a notification may include payment tracking. From an initial request initiated by a payor through a receipt of a payment by a payee, an electronic payment may pass through various stages and/or from one entity to another. A notification may be communicated as the payment passes through each stage and/or each entity from the initial request by the payor until a receipt of funds by the payee.

For example, a notification preference may specify that a payor is to be notified by SMS text message after a payment has been credited to an account of a payee. The text message sent to the payor may serve as a confirmation of receipt.

As another example, online bill payment typically involves a payor, an intermediary (such as a bank, a billpay service or a billpay network) and a payee. Electronic payments may be processed by Automated Clearing House (“ACH”). A notification may be communicated to the payor and/or payee when ACH has received the payment. A notification may be communicated to the payee indicating an approximate date/time when the payment will be available to the payee.

A notification preference may be automatically stored in a database for future reference.

In some embodiments, the apparatus and methods may communicate notification regarding a file attachment sent from a payor to a payee. An attachment may be appended to a payment using apparatus and methods shown and described in co-pending, commonly assigned U.S. patent application Ser. No. 12/193,947 entitled “Online Billpay Payment Attachments,” which is hereby incorporated herein by reference in its entirety.

A file attachment may include a signed contract for products or services, a payment stub with descriptive details of the payment, a photo of an item being purchased, or any other document that the payor wishes to send in connection with the payment.

An attachment may take the form of electronic file. The file may be uploaded to a payment intermediary, such as a bank, a billpay service, a billpay network, or any other suitable intermediary. The attachment may originate as a file from the payor's computer, a scan from a scanner, a fax, a photo, an audio and/or video recording, or any other means of electronic document capture. An attachment may be in any suitable data format, such as DOC, PDF, TIFF, WAV, MP3, or JPEG.

A notification may indicate the data format of the attachment or a source from where the attachment originated. A notification may provide an indication of the contents of the attachment. Notification may provide notice to the payor that the payee has accessed a payment and/or an attachment.

A notification may be communicated indicating that an attachment has been scanned for malware or inappropriate content. A notification including the results of a scan for malware or inappropriate content may prevent intentional or unintentional dispersion of malicious software code, digital rights violations, or harassing images or content.

A notification may be communicated indicating that an attachment may be made available to the payee whether or not the payee is a customer or member of the payment intermediary (bank, network, or otherwise) and whether the payment was made electronically (e.g., by Automated Clearing House (“ACH”) or other method) or by paper (check, draft, etc.)

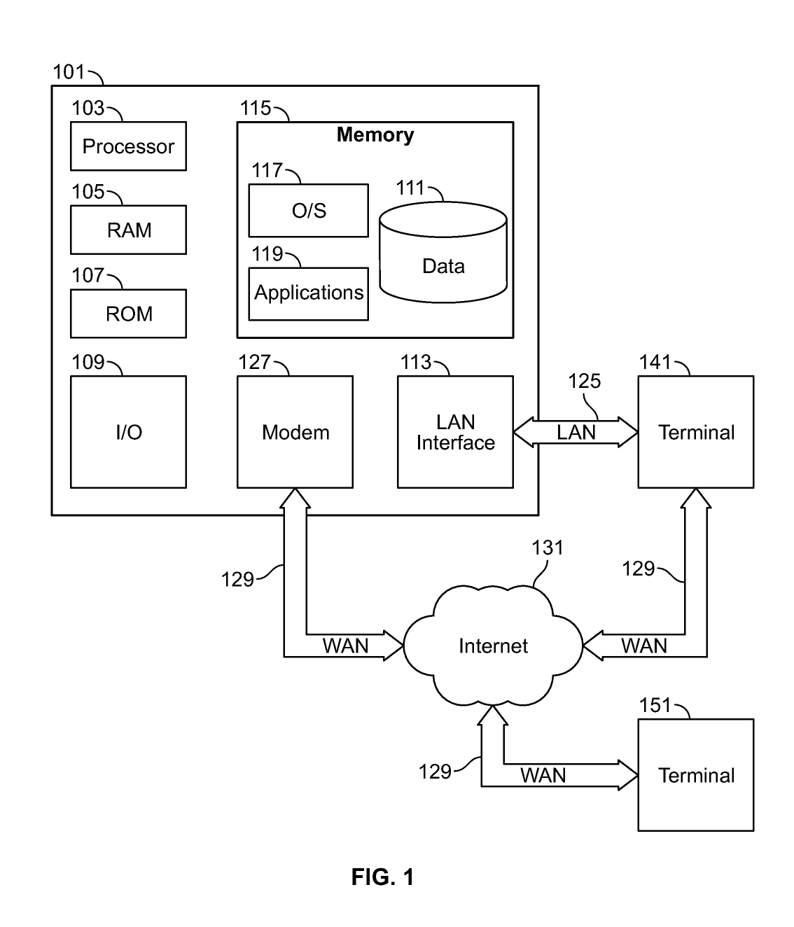

In the case of an electronic payment, a notification may include a preferably secure link that would enable the payee to view or download the attachment. In the case of paper payment, a notification may include instructions and a file-code or link-name that, if entered into an internet accessible computer terminal (see FIG. 1, item 151), would enable viewing or downloading of the attachment. Whether a payment is in paper or electronic form, notification may be provided in the form of a paper copy of the attachment.

A notification may include details regarding a payment. Details may include a date the payment was sent, an amount of the payment, the payor and/or payee, or a transaction path of the payment. The transaction path may include one or more intermediaries that have processed or transmitted a request for payment from initiation by the payor to receipt of funds by the payee.

A notification may provide notice to a payee that a payor has made a payment that is substantiated, qualified, conditioned or otherwise modified. This may give the payor an opportunity, for example, to timely contact the payee to resolve shipment or billing disputes.

Additionally, notification verifying an anticipated payment may allow a payee to trade based on an expected payment. For example, a payee may receive notification verifying that in three days a payment of $100.00 USD is to be credited to the payee. The payee may present the notification to a speculator who may be willing to pay the payee $99.00 USD now for the right to collect the full $100.00 USD in three days.

In some embodiments, a notification may indicate whether a payment/attachment has been viewed, printed and/or saved.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 101 computer executable instructions may be embodied in hardware or firmware (not shown). As described in detail below, database 121 may provide storage for notification information, notification content, file attachments, history of notifications sent, and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a smartphone, tablet device, mobile phone, battery, speaker, and antennas (not shown).

A client of a financial institution may use a terminal such as 141 or 151 to access a billpay platform administered by an intermediary. Billpay information, including payee information, payor information, historical payment records, data objects for attachment, and any other suitable information, may be stored in memory 125.

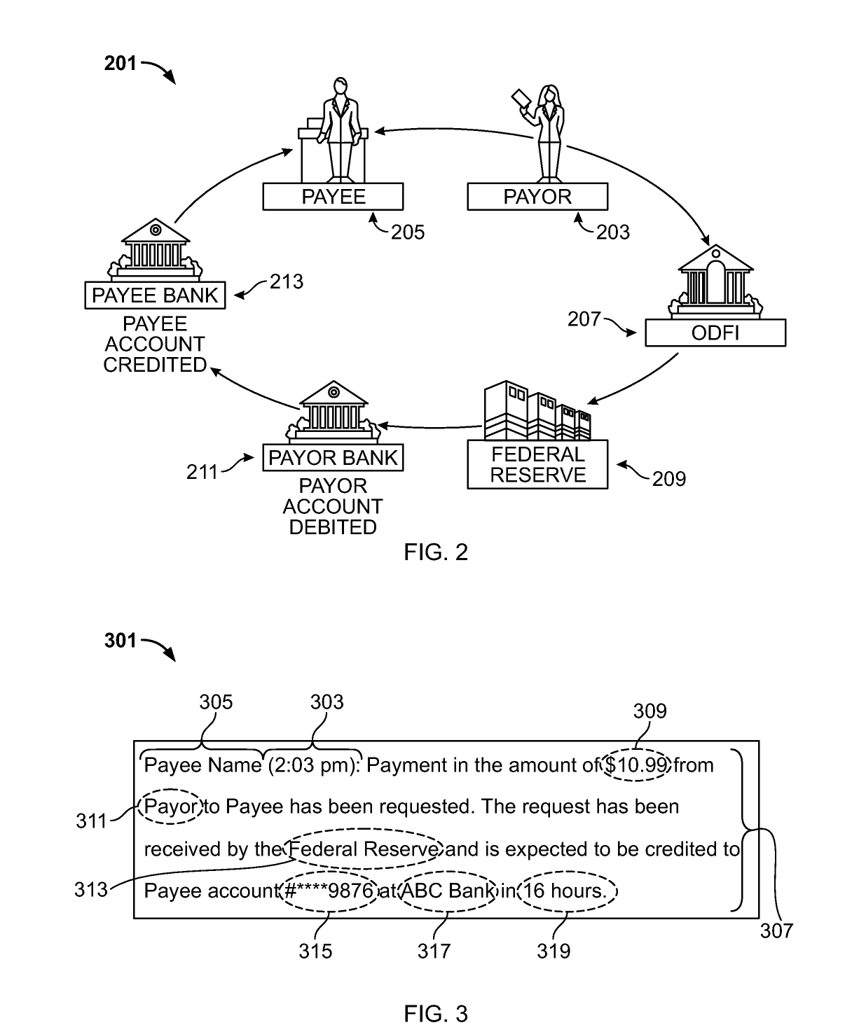

FIG. 2 shows a flow diagram of payment network intermediaries that may process a payment request. The process 201 may begin when, at step 203, a payor initiates a request for a payment to be received by payee at step 205.

To complete the request for payment, at step 207, the payment request is submitted to an Originating Depository Financial Institution (“ODFI”). The ODFI may review the payment request and warrant to any other transferees that the payment request conforms to pre-determined standards.

At step 209, the ODFI may submit the request for payment to Federal Reserve. The Federal Reserve retains deposit accounts of various financial institutions and may credit or debit those accounts as directed in the request for payment.

After accounts held at the Federal Reserve have been settled, at step 211, an account of the payor may be debited. At step 213, the payee's account may be credited for the amount of the payment request. After the payee's account has been credited, the payee may withdraw the amount of the payment request (not shown).

A notification may be transmitted when the request for payment is at any stage of FIG. 2. For example, at step 209 a notification may be transmitted to the payee informing the payee that the request for payment is being processed by the Federal Reserve. The notification may include information indicating an approximate timeframe for the payment to be available for withdrawal by the payee.

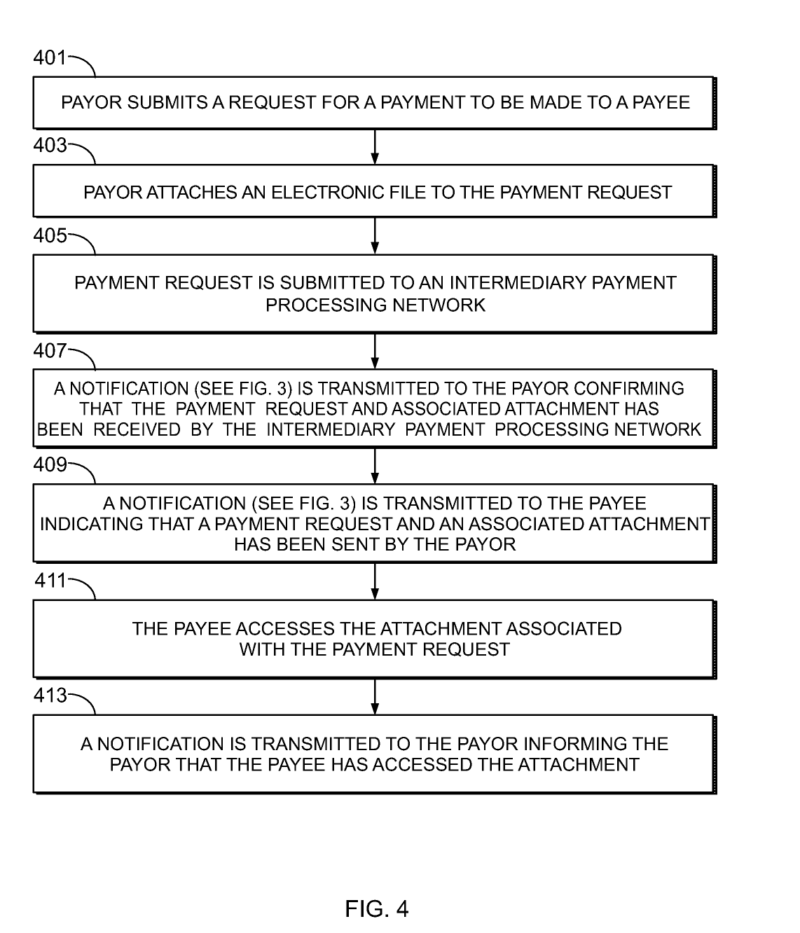

FIG. 3 shows a sample notification that may be transmitted to a payee. The notification may be sent as a SMS text message to a mobile phone. The mobile phone may be identified by an international phone number.

The notification may include the name of the payee 305 and a time 303 the notification is transmitted. The notification may include a body 307.

The body 307 may include a payment amount 309. The body may indicate a current status of the payment request 313. The body may include an account number 315 held at a particular bank 317 that is to be credited the value of the payment amount 309.

The body may include a timeframe 315 indicating when the payment amount 309 is expected to be credited to the payee 305.

FIG. 4 is flow diagram that shows a process in accordance with the principles of the invention. At step 401, a payor submits a request for a payment to be made to a payee. At step 403, the payor attaches an electronic file to the payment request. The electronic file may be an image, a contract or may contain any information relevant to the payment request.

At step 405, the payment request is submitted to an intermediary payment processing network. At step 407, the payor may receive a notification (see FIG. 3) confirming that the payment request and associated attachment has been received by the intermediary payment processing network.

At step 409, a notification (see FIG. 3) may be transmitted to a payee indicating that a payment request and an associated attachment has been sent by the payor. The attachment may be made available to the payee via a secure link included in the attachment (not shown).

At step 411, the payee may access the attachment associated with the payment request. At step 413, a notification may be transmitted to the payor informing the payor that the payee has accessed the attachment.

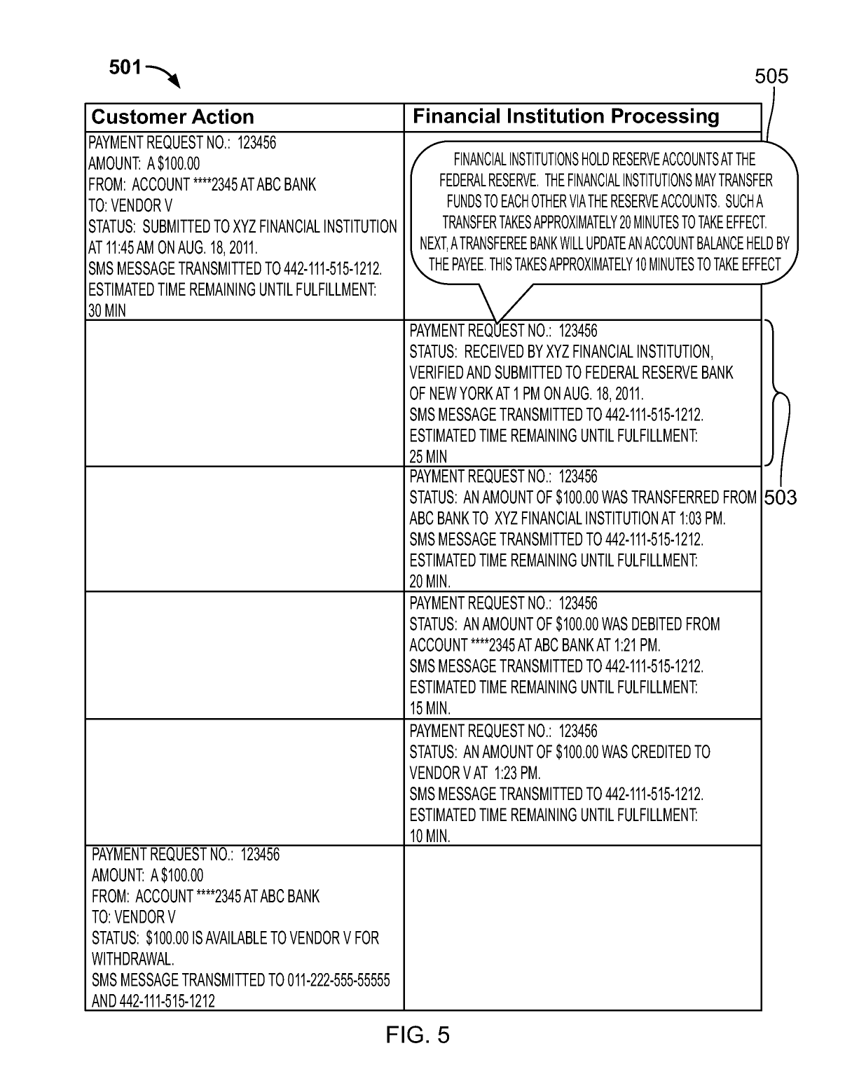

FIG. 5 shows illustrative information that may be included in a notification. Report 501 may track a status of a payment request from initiation by a payor until the payment amount is available for withdrawal by a payee.

As the payment request is passed from one entity to another, an entry may be added to report 501. Report 501 shows a current status of a payment request. Explanatory text may appear when a customer “hovers over” an entry with a pointing device.

For example, when a customer “hovers over” entry 503, explanatory text 505 is displayed. Explanatory text 505 explains why the payment request has been transferred and why it will take 30 minutes for the request to be fulfilled. Explanatory text may include any other suitable explanatory information.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for SMS beneficiary advising have been provided. Persons skilled in the art will appreciate that the present invention can be practiced by other than the described embodiments, which are presented for purposes of illustration rather than of limitation. The present invention is limited only by the claims that follow.

What is claimed is:

1. One or more non-transitory computer-readable media storing computer-executable instructions which, when executed by a processor on a computer system, provide a method for electronically communicating a notification of a payment of funds from a payor to a payee, the method comprising:
receiving an electronic request from the payor requesting the payment of funds to the payee;
receiving notification information specifying a method of communication of a notification, a destination for the notification and content of the notification;
tracking a status of the payment; and
communicating the notification to the destination.

2. The media of claim 1 wherein the notification information is provided by the payor.

3. The media of claim 1 wherein the notification information is provided by the payee.

4. The media of claim 2 wherein the destination is the payee.

5. The media of claim 3 wherein the destination is the payor.

6. The media of claim 1 wherein:
the electronic request comprises a file attachment sent from a payor to a payee; and
the content of the notification indicates whether the attachment has been scanned for malicious software code or a digital rights violation.

7. The media of claim 1 wherein:
the electronic request comprises a file attachment sent from a payor to a payee; and
the notification comprises an electronic link that enables the payee to view or download the file attachment.

8. The media of claim 1 wherein the content of the notification indicates that the payee has accessed the payment or the file attachment.

9. The media of claim 1 wherein the content of the notification comprises a date of the electronic request.

10. The media of claim 1 wherein the content of the notification comprises an amount of the payment.

11. The media of claim 1 wherein the content of the notification comprises a current status of the payment.

12. The media of claim 11 wherein the content of the notification indicates when the payment will be available to the payee.

13. The media of claim 11 wherein the notification is sent to the destination each time the electronic request passes from one entity to another entity.

14. The media of claim 1 wherein the destination of the notification is an international phone number.

15. The media of claim 1 wherein the notification is communicated via SMS text message.

16. A system configured to communicate a notification, the notification indicating a status of a payment from a payor to a payee, the system comprising:
a receiver device configured to receive an electronic request from the payor requesting the payment;
a processor device configured to track the status of the payment;
a transmitter device configured to transmit the notification to a destination.

17. The system of claim 16 wherein the receiving device is configured to receive a file attachment associated with the payment.

18. The system of claim 17 wherein the notification indicates:
a current status of the payment;
when the payment will be available to the payee;
an amount of the payment and
an electronic link that enables the payee to view or download the file attachment.

19. The system of claim 18 wherein the transmitter is configured to transmit the notification to an international phone number.

20. The system of claim 19 wherein the transmitter is configured to transmit the notification via SMS text message.
